(19) United States
(12) Patent Application Publication
(10) Pub. No.: US 2017/0161288 A1
(43) Pub. Date: Jun. 8, 2017

(54) DATA ANALYTICS ENGINE FOR FACILITATING REAL-TIME SUBSCRIBER BASED DATA ANALYSIS

(71) Applicant: OSNEXUS Corporation, Bellevue, WA (US)

(72) Inventors: David Feldman, Santa Monica, CA (US); Steven Michael Umbehocker, Mercer Island, WA (US)

(21) Appl. No.: 15/368,111

(22) Filed: Dec. 2, 2016

Related U.S. Application Data
(60) Provisional application No. 62/262,201, filed on Dec. 2, 2015.

(51) Int. Cl. G06F 17/30

(52) U.S. Cl. CPC G06F 17/30091; G06F 17/3012; G06F 17/3007

(57) ABSTRACT

A data analytics engine for facilitating real-time data analysis by respective subscriber based analytics processors is presented herein. An analytics engine component can generate even messages representing detected file-system events, e.g., comprising a creation, a modification, a read, a deletion, an open, a close, etc. of a file of a block device, a file system, etc. Further, the analytics engine component can store the event messages in a memory; receive defined notification criteria from a group of subscriber devices; and in response to determining that an event message of the event messages satisfies a defined notification criterion of the defined notification criteria corresponding to a subscriber device of the group of subscriber devices, send the event message directed to the subscriber device to facilitate an analysis of data corresponding to an access of the accesses of a file of the respective files.

### PRIORITY CLAIM

This patent application claims priority to U.S. Provisional Patent Application Ser. No. 62/262,201, filed on Dec. 2, 2015, entitled “REAL-TIME DATA ANALYTICS ENGINE”, the entirety of which application is hereby incorporated by reference herein.

### TECHNICAL FIELD

This disclosure relates generally to data analytics, but not limited to, a data analytics engine for facilitating real-time subscriber based data analysis.

### BACKGROUND

The proliferation of computing devices has subsequently increased an amount of data being processed and stored within various storage media (including solid state, magnetic, optical, virtual, etc.). In this regard, determining details about data storage access can be burdensome and require customized data analytic environments that are costly and difficult to maintain across varied computing environments. Consequently, conventional data analysis technologies have had some drawbacks, some of which may be noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a real-time data analytics service environment with a data storage device comprising a file event notification component and an analytics engine component, in accordance with various example embodiments;

FIG. 2 illustrates a block diagram of a real-time data analytics service environment with an analytics engine component communicatively coupled to a data storage device, in accordance with various example embodiments;

FIG. 3 illustrates a block diagram of a real-time data analytics service environment with different subscribers, in accordance with various example embodiments;

FIG. 4 illustrates a block diagram of a real-time data analytics service comprising a data access component, in accordance with various example embodiments;

FIG. 5 illustrates a block diagram of a subscriber/analytics processing component communicatively coupled to a data container manager component, in accordance with various example embodiments;

FIG. 6 illustrates a block diagram of a real-time data analytics service environment with a data storage device comprising a data access component, in accordance with various example embodiments;

FIG. 7 illustrates a block diagram of a subscriber system corresponding to a real-time data analytics service, in accordance with various example embodiments;

FIGS. 8-10 illustrate flow diagrams of a method associated with an analytics engine component, in accordance with various example embodiments;

FIG. 11 illustrates a flow diagram of a method associated with a subscriber system, in accordance with various example embodiments; and

FIG. 12 illustrates a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, determining details about specific data storage access can be burdensome and require customized data analytic environments that are costly and difficult to maintain across varied computing environments. Various embodiments described herein can provide an open, “pluggable” data analytics infrastructure from which disparate user/subscriber devices can register/subscribe to receive, from an analytics engine, notifications of defined file activities/events that have been detected by the analytics engine. In turn, based on the notifications, the subscriber devices can perform customized, real-time analysis of information corresponding to the defined file activities/events.

For example, a data storage system can comprise a file event notification component and an analytics engine component. The file event notification component (e.g., inotify, a filter driver, etc.) can generate, in response to detection of accesses, e.g., open, close, create, delete, read, modify, etc. of respective files of a data storage device (e.g., a block device, a file system, a network block device, a virtual block device, etc.), file-system events representing the accesses. Further, the file event notification component can send the file-system events to the analytics engine component.

In an embodiment, the detection of the accesses can comprise detecting the accesses utilizing a filter driver that has been installed on the data storage device, a function call executed via a kernel of the data storage device (e.g., inotify, stat, etc.), a device driver that has been installed on the data storage device, etc. In another embodiment, the detection of the accesses can comprise detecting that a file of the respective files has been opened, closed, created, modified, read, deleted, etc. In yet another embodiment, the detection of the accesses can comprise detecting an input/output (I/O) latency of an access of the file, a data throughput associated with the access, etc. In turn, information representing the I/O latency and/or the data throughput can be included in a file-system event of the file-system events corresponding to the access.

The analytics engine component can receive defined notification criteria, e.g., via subscription/registration requests, from a group of subscriber devices. Further, the analytics engine component can receive the file-system events from the file event notification component, generate subscriber event messages representing the file-system events, and store the subscriber event messages in a queue, first-in first-out (FIFO) memory, etc. In turn, in response to a subscriber event message of the subscriber event messages being determined to satisfy a defined notification criterion of the defined notification criteria corresponding to a subscriber device of the group of subscriber devices, the analytics engine component can send the subscriber event message directed to the subscriber device (e.g., an analytics processing component) to facilitate a customized analysis, by the analytics processing component, of data corresponding to a file-system event of the file-system events.

In this regard, the customized analysis performed by the analytics processing component can comprise, e.g., a real-time statistical analysis representing a performance of the data storage device; a security analysis representing authorized/unauthorized access of files that have been stored in the data storage device; a file analysis representing a number, capacity, owners, etc. of particular types of the files; a data governance analysis representing who accessed the files and when they were accessed/attempted to be accessed, etc.

In an embodiment, the subscriber event message can comprise metadata, e.g., comprising an Extensible Markup Language (XML) format, a JavaScript Object Notation (JSON) format, a Hypertext Transfer Protocol (HTTP) based format, etc. representing the access, file-system event, etc. In embodiment(s), the metadata can represent: a type of the file, a file name of the file, an extension name of an extension of the file, a location of the file within the data storage device, an operation that has been performed on the file, a time corresponding to an initiation of the operation, a size of the file, an entity identity representing an entity, user, etc. that performed the access, etc.

In one embodiment, the analytics engine component can be separate from the data storage system, e.g., communicatively coupled to the file event notification component via an out-of-band network interface, e.g., Internet, etc. In this regard, in embodiment(s), the analytics engine component can receive the file-system events from the file event notification component using a representational state transfer (REST/RESTful) based web service.

In another embodiment, the analytics engine component can receive defined notification criteria, e.g., subscription/registration requests, from the group of subscriber devices (e.g., disparate, customizable, analytics processing components) utilizing respective application programming interfaces (APIs) corresponding to the group of subscriber devices. For example, in embodiment(s), the respective APIs can be registered with the analytics engine component to enable the analytics engine component to receive, via application programming interface (API) calls), the defined notification criteria from the disparate, customizable, analytics processing components. Further, the respective APIs can enable the analytics engine component to send respective event messages to the disparate, customizable, analytics processing components.

In yet another embodiment, the analytics engine component can receive the defined notification criteria, e.g., subscription/registration requests, from the group of subscriber devices using a REST/RESTful based web service.

In an embodiment, a method can comprise generating, by a system comprising a processor, e.g., via an analytics engine component, an event notice comprising information representing a detected activity that has been performed on a file of a data storage device; storing, by the system, the event notice in an event queue ((e.g., FIFO, etc.); and receiving, by the system, a registration request from a subscriber device—the subscriber request comprising a defined condition for selection of the event notice from the event queue.

Further, the method can comprise sending, by the system, the event notice directed to a subscriber device for facilitating an analysis, e.g., via the subscriber device, of data associated with the file—in response to determining, based on the information, that the event notice satisfies the defined condition for the selection of the event notice from the event queue.

In one embodiment, the method can further comprise detecting, by the system, the activity using a filter driver operating on the data storage device, a device driver operating on the data storage device, and/or a function call of the data storage device. Further, the generating of the event notice can comprise generating the event notice using the filter driver, the device driver, and/or the function call.

In another embodiment, the detecting of the activity can comprise detecting a creation of the file, an access of the file, a modification of the file, a read of file, a write to the file, or a deletion of the file. In another embodiment, the detecting of the activity can comprise detecting the activity in response to determining that a group of activities that that have been registered with the system, e.g., via an API associated with the subscriber device, comprises the activity.

In yet another embodiment, a machine-readable storage medium can comprise executable instructions that, when executed by a processor, e.g., when executed by an analytics processing device comprising the processor, facilitate performance of operations, comprising: sending, e.g., via an API corresponding to the analytics processing device, a group of event subscription requests to an analytics engine device—the group of event subscription requests facilitating identification, by the analytics engine device, of respective access events of a file; and based on the group of event subscription requests, receiving the respective access events from the analytics engine device, e.g., to facilitate further processing, by the analytics processing device, of data corresponding to the respective access events.

In an embodiment, the respective access events can comprise: a creation of the file, an access of the file, a modification of the file, a read of file, a write to the file, or a deletion of the file.

In another embodiment, the sending of the group of event subscription requests to the analytics engine device comprises registering, via the API of the analytics engine device, the group of event subscription requests with the analytics engine device. In this regard, a request of the group of event subscription requests comprises a subscribe function comprising function arguments for facilitating the identification, by the analytics engine device, of an access event of the respective access events.

For example, in one embodiment, the function arguments can specify: a type of the file; a file name of the file; an extension name of an extension of the file; a location of the file within the data storage device; an operation that has been performed on the file; a time corresponding to an initiation of the operation, a size of the file; an entity identity representing an entity that performed the access, etc. In another embodiment, the function arguments can comprise a regular expression syntax comprising a sequence of characters that define a search pattern, e.g., an XML based syntax, a JSON based syntax, an HTTP based syntax, etc.

In yet another embodiment, the operations can comprise: reading, via the analytics engine device, data of the file; and storing, by the analytics processing device, the data in data store, e.g., data container, to facilitate an analysis, by the analytics processing device, of the data. For example, in embodiment(s), the analytics processing device can determine/perform, based on the data, a real-time statistical analysis representing a performance of the data storage device; a security analysis representing authorized/unauthorized access of files that have been stored in the data storage device; a file analysis representing a number, capacity, owners, etc. of particular types of the files; a data governance analysis representing who accessed the files and when they were accessed/attempted to be accessed, etc.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

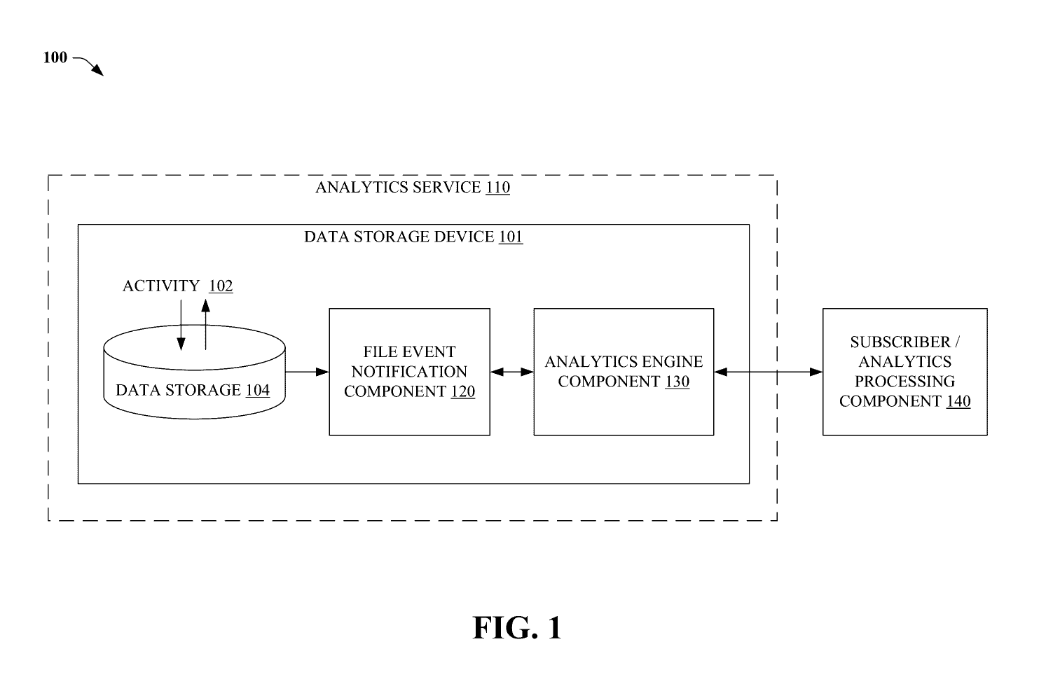

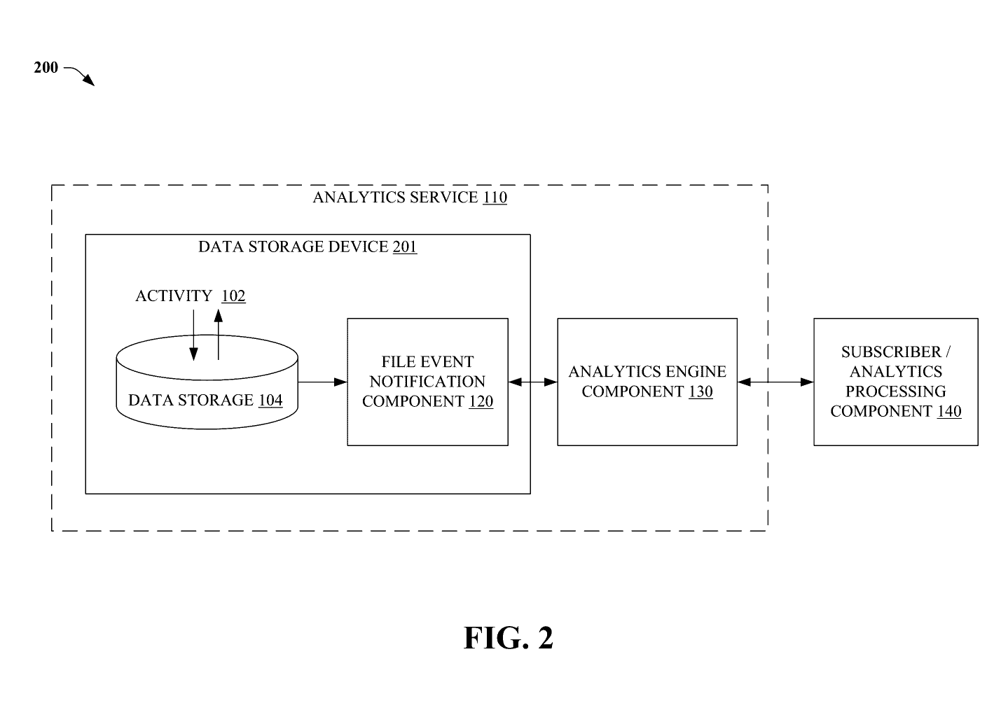

Referring now to FIGS. 1 and 2, block diagrams (100, 200) of real-time data analytics service environments are illustrated, in accordance with various embodiments. In this regard, analytics service 110 can provide a “configurable” data analytics infrastructure from which different users can subscribe to receive notifications of defined input/out file activities, events, etc. of a storage device, and use such notifications to effectively perform customized analytics, e.g., real-time performance statics of the data storage device, security analysis of accesses that have been performed on the data storage device, file access analytics regarding type of files accessed, a number of the type of files accessed, data governance analytics regarding who accessed files and when the files were accessed, etc.

As illustrated by FIG. 1, data storage device 101 comprises data storage 104 (e.g., a block device, a file system, a network block device, a virtual block device, etc.), file event notification component 120, and analytics engine component 130. In this regard, file event notification component 120 (e.g., inotify, a filter driver, etc.) can detect accesses, e.g., activity 102, of respective files of data storage 104. For example, in embodiment(s), activity 102 can comprise processes related to creating a file in data storage 104, modifying the file, reading the file, deleting the file, opening the file, closing the file, etc. In other embodiment(s), file event notification component 120 can detect properties, e.g., an I/O latency of an access of the accesses, a data throughput associated with the access, etc.

Further, in response to detecting activity 102, file event notification component 120 can generate message file-system event representing an access corresponding to activity 102, and send the file-system event to analytics engine component 130. In turn, analytics engine component 130 can receive the file-system event from file event notification component 120, generate a subscriber event message representing the file-system event, and store the subscriber event message in a queue (see e.g., event queue 222 below), a FIFO memory, etc.

In this regard, a subscriber device, e.g., subscriber/analytics processing component 140, can register a defined, custom, etc. notification criteria with analytics engine component 130, e.g., utilizing a subscription/registration function call corresponding to the subscriber device that has been defined by an API of analytics engine 130.

Based on the defined, custom, etc. notification criterion that has been received from the subscriber device, analytics engine component 130 can review subscriber event messages that have been stored in the queue, and in response to determining that the subscriber event message satisfies the defined notification criterion, analytics engine component 130 can send the subscriber event message directed to the subscriber device for facilitating a performance, by the subscriber device, of a customized analysis of data of the access corresponding to activity 102.

In an embodiment illustrated by FIG. 2, analytics engine component 130 can be separate from a data storage device (e.g., data storage device 201) that comprises data storage 104 and file event notification component 120. In this regard, analytics engine component 130 can be communicatively coupled to file event notification component 120 via an out-of-band network interface, e.g., Internet, etc. In this regard, in embodiment(s), analytics engine component 130 can receive file-system events from file event notification component 120 using a REST/RESTful based web service, interface, etc.

Further, in embodiment(s), data storage 104 can comprise a block storage device, a virtual block storage device, a “just a bunch of disks” (JBOD) storage device, a redundant array of inexpensive disks (RAID) “bunch of disks” (RBOD) storage device, a virtual storage appliance, etc. Further, data storage 104 can comprise: Small Computer System Interface (SCSI) storage devices, which are based on a peripheral, peer-to-peer interface that can be used, e.g., in personal computer (PC) server systems; Serial Advanced Technology Attachment (SATA) storage devices; SCSI-over-Fiber Channel storage devices; SAS devices; Internet SCSI (iSCSI) devices, which are associated with an Internet Protocol (IP) based storage networking standard for linking data storage facilities and/or entities; Advanced Technology (AT) Attachment (ATA) storage devices; ATA over Ethernet (AoE) storage devices; other Storage Area Network (SAN) devices, cloud-based data storage devices, etc.

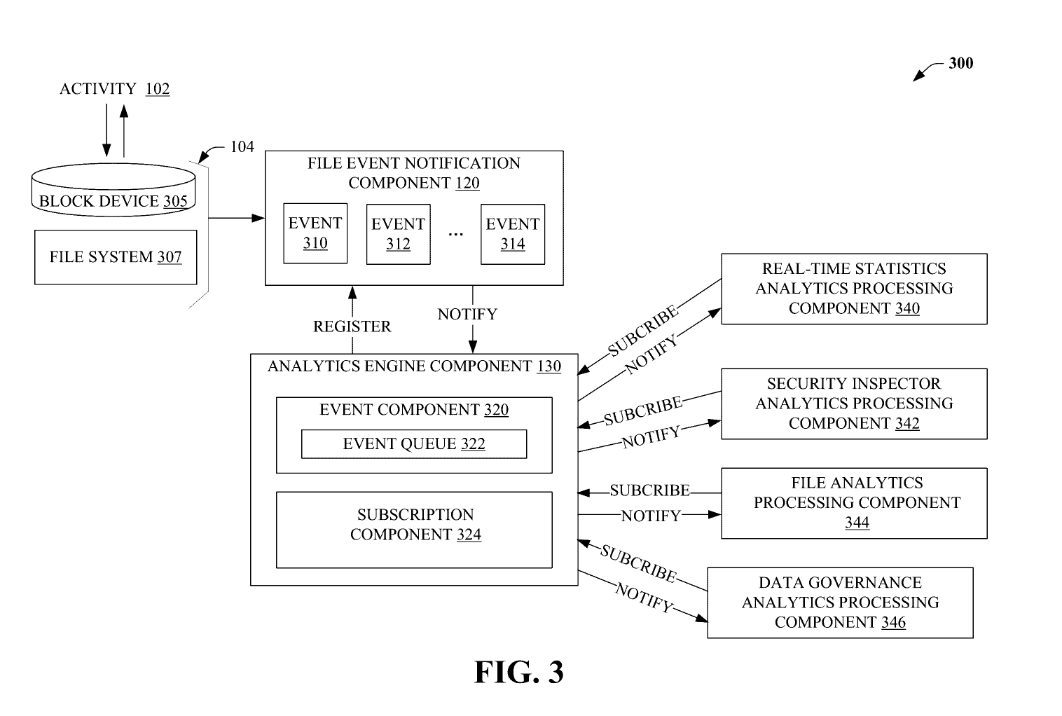

Referring now to FIG. 3, a block diagram (300) of a real-time data analytics service environment with different subscribers is illustrated, in accordance with various embodiments. File event notification component 120 can detect an activity (102) being performed on a file of data storage 104 (e.g., block device 305, file system 307) utilizing, e.g., a filter driver that has been installed on data storage 104, a function call executed via kernel of data storage 104 (e.g., inotify, stat), a device driver that has been installed on data storage 104, etc. As described above, the activity can be associated with a write of the file, a read of the file, a modification of the file, a deletion of the file, an open operation performed on the file, a close operation performed on the file, etc.

In this regard, in response to detecting the activity, file event notification component 120 can generate file-system events (e.g., an event notice, object, etc. (e.g., event 310, event 312, event 314)) comprising information representing the activity.

Analytics engine component 130 can comprise event component 320 and subscription component 324. In this regard, in response to activity 102 being detected, event component 320 can receive, from file event notification component 120 (e.g., asynchronously with respect to activity 102), the file-system events, e.g., events (310, 312, 314), generate subscriber event messages (not shown) representing the file-system events, and store the subscriber event messages in event queue 322, e.g., a FIFO memory, etc.

In embodiment(s), the subscriber event messages can comprise metadata comprising, e.g., an XML format, a JSON format, an HTTP based format, etc., and representing, e.g., a type of the file, a file name of the file, an extension name of an extension of the file, a location, or file path, of the file, an operation, e.g., read, write, delete, modify, etc. that has been performed on the file, a time corresponding to an initiation of the operation, a size of the file, an entity identity representing an entity, user, etc. that performed the activity, etc.

Subscription component 324 can receive registration requests from respective subscriber devices, e.g., real-time statistics analytics processing component 340, security inspector processing component 342, file analytics processing component 344, data governance analytics processing component 346, etc. In this regard, the registration requests can be received by subscription component 324 utilizing APIs corresponding to the respective subscriber devices. For example, in embodiment(s), a registration request can comprise a subscribe function, e.g., defined by an API of the APIs corresponding to a subscriber device of the respective subscriber devices. The subscribe function can comprise function arguments for facilitating identification, by event component 320, of an access event of the respective access events, e.g., of interest to the subscriber device, from event queue 322, e.g., for facilitating customized processing, by the subscriber device, of information, data, etc. corresponding to the access event.

In one embodiment, a pseudo code, syntax, etc. of the subscribe function can comprise “subscribe (argument 1, argument 2 . . . argument N)”, in which function arguments (argument 1, argument 2, argument N) of the subscribe function specify, define, etc. notification criteria of the subscriber device—event component 320 utilizing such notification criteria to identify, filter, select, etc. event notification(s) from event queue 322.

In this regard, the function arguments can specify, e.g., file event type(s), file operation(s), file type(s), file name extension(s), file location(s), file content, file size(s), file timestamp(s), a range of file size, a range of file access times, an entity identity representing an entity, user, etc. that event component 320 can utilize to identify, filter, select, etc. event notification(s) from event queue 322.

In an embodiment, the function arguments can comprise a regular expression syntax comprising a sequence of characters that define a search pattern, e.g., an XML based syntax, a JSON based syntax, an HTTP based syntax, etc., e.g., for identifying activity 102 corresponding to particular file extensions, files names, file operations, users, etc.

In other embodiment(s), subscription component 324 can receive the registration request from the respective subscriber devices using a REST/RESTful based protocol, web service, etc.

In turn, in response to subscription component 324 determining, based on the registration request, that a subscriber event message, notice, etc. satisfies a notification criterion of the notification criteria corresponding to the subscriber device, subscription component 324 can send the subscriber event message, notice, notification, etc. to the subscriber device to facilitate a subscriber-based, custom analysis of data corresponding to the subscriber event message, notice, etc.

For example, as illustrated by FIG. 3, in one embodiment, the subscriber device can comprise real-time statistics analytics processing component 340, which can receive the subscriber event message, notice, notification, etc. from analytics engine component 130, and, based on the subscriber event message, perform a real-time statistical analysis representing a performance of data storage 104. For example, real-time statistics analytics processing component 340 can obtain, e.g., via data access component 410 (see below), information representing, e.g., an available storage capacity of data storage 104, a performance of data storage 104, a processing time of an operation, e.g., access time, read time, write time, etc. represented by the subscriber event message, etc.

In another embodiment, the subscriber device can comprise security inspector analytics processing component 342, which can perform, based on the subscriber event message, etc. an analysis of authorized/unauthorized accesses of files that have been stored in data storage 104. For example, in one embodiment, security inspector analytics processing component 342 can tag, write, etc. file data in a file, e.g., utilizing data access component 410 (see below), e.g., to categorize the file as comprising confidential, secure, etc. information—based on a subscriber event message indicating that the file comprises data that has been specified (e.g., based on a registration request) to be associated with confidential, secure, etc. information.

In yet another embodiment, security inspector analytics processing component 342 can determine, based on the subscriber event message, that a file has been accessed by an entity, user, etc. that has been specified via registration request. In turn, security inspector analytics processing component 342 can store information representing the entity, user, etc. in a storage device (see e.g. data container 520 below), e.g., for facilitating a determination of whether the entity, user, etc. was authorized to access the file.

In one embodiment, the subscriber device can comprise file analytics processing component 344, which can identify, based on the subscriber event message, file(s) corresponding to a file type, a file extension, a file size/capacity, a file owner, etc. that has been specified to be filtered, selected, etc. via the registration request. In turn, file analytics processing component 344 can store information representing the file(s) in a storage device (see e.g. data container 520 below), e.g., for facilitating a determination of how many files corresponding to a particular criterion are included in data storage 104.

In another embodiment, the subscriber device can comprise data governance analytics processing component 346, which can identify, based on the subscriber event message (e.g., utilizing data access component 410), information representing who, e.g., which user(s), accessed particular file(s), when the file(s) were accessed/attempted to be accessed, etc. In turn, data governance analytics processing component 346 can store the information in a storage device (see e.g. data container 520 below), e.g., for facilitating an analysis of accesses of files of data storage 104.

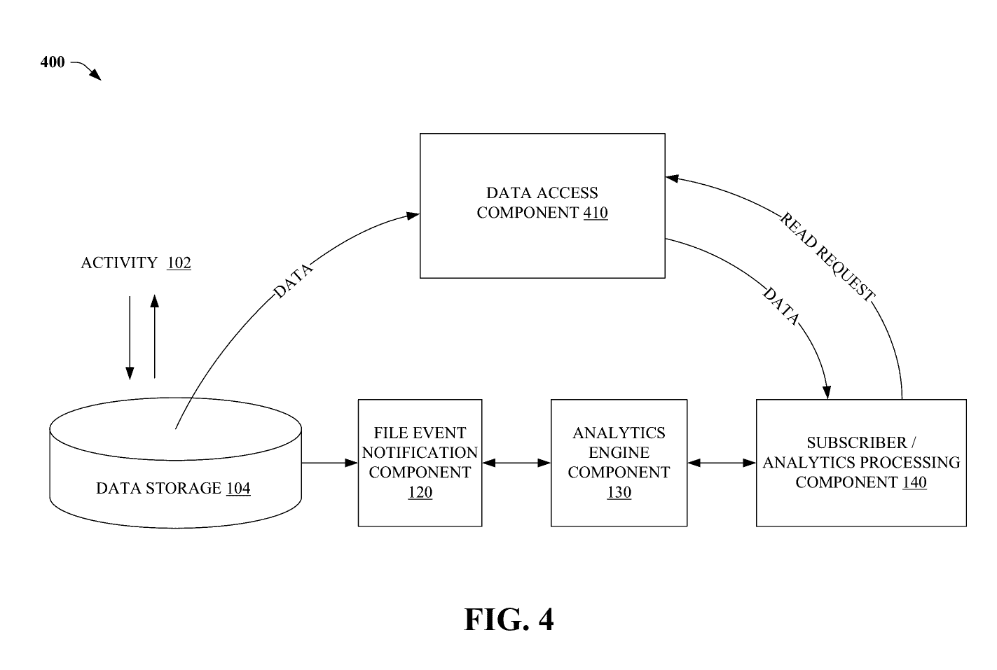

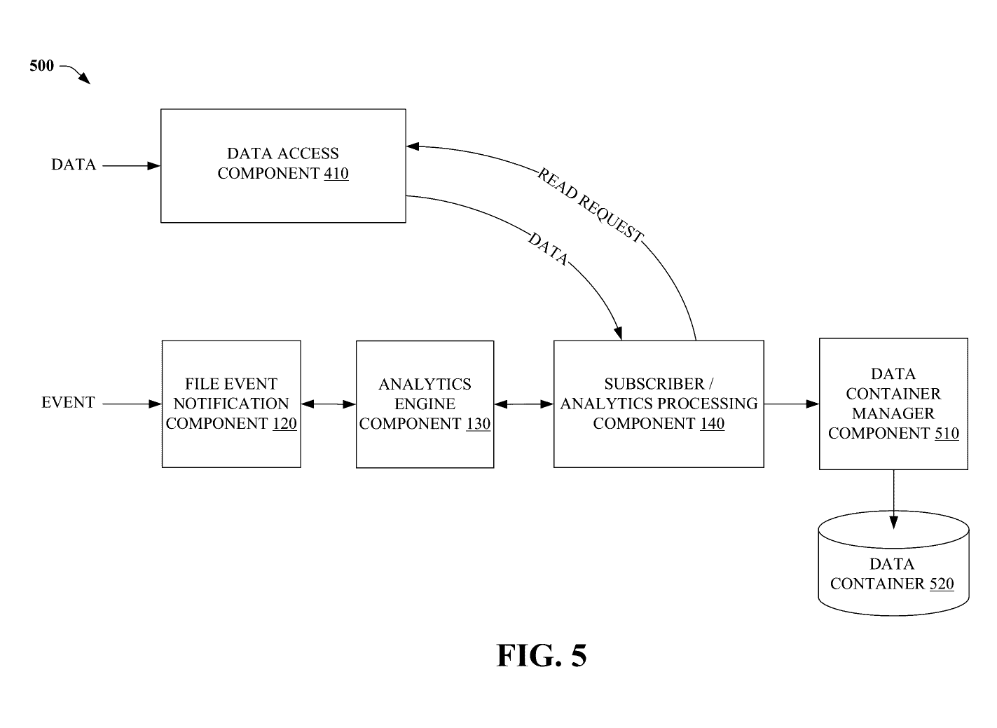

Referring now to FIGS. 4 and 5, block diagrams (400, 500) of real-time data analytics services (e.g., analytics service 110) comprising a data access component (410), and a data container manager component (510), respectively, are illustrated, in accordance with various embodiments. In this regard, data access component 410 can receive a read request from a subscriber device, e.g., subscriber/analytics processing component 140, to instruct data access component 410 to read, e.g., based on an event message that was received by the subscriber device, portion(s) of data storage 104 specified in the read request.

In turn, the subscriber device can store, utilizing data container manager component 510, the portion(s) of the data in a data storage device, e.g., data container 520, and analyze information represented by the portion(s) of data.

For example, in one embodiment, real-time statistics analytics processing component 340 can store in data container 520, via data container manager component 510, information representing, e.g., an available storage capacity of data storage 104, a performance of data storage 104, a processing time of an operation (e.g., a file access time, a file read time, a file write time, etc.) corresponding to a received event message—to facilitate customized analysis of the information by real-time statistics analytics processing component 340.

In another embodiment, security inspector analytics processing component 342 can store, via data container manager component 510, information representing, e.g., an entity, user, etc. that has accessed a file of data storage 104—to facilitate determination(s), by data container manager component 510, of security breach(es), unauthorized access(es) of information, etc. of data storage 104.

In yet another embodiment, file analytics processing component 344 can store, via data container manager component 510, information representing characteristic(s) of file(s) of data storage 104—to facilitate identification of files of data storage 104 corresponding to a particular criterion, e.g., name, extension, size, owner, type, etc.

In an embodiment, data governance analytics processing component 346, can store, via data container manager component 510, information representing who accessed particular file(s), when the particular file(s) were accessed/attempted to be accessed, etc.—to facilitate an analysis of defined access(es) of the such file(s).

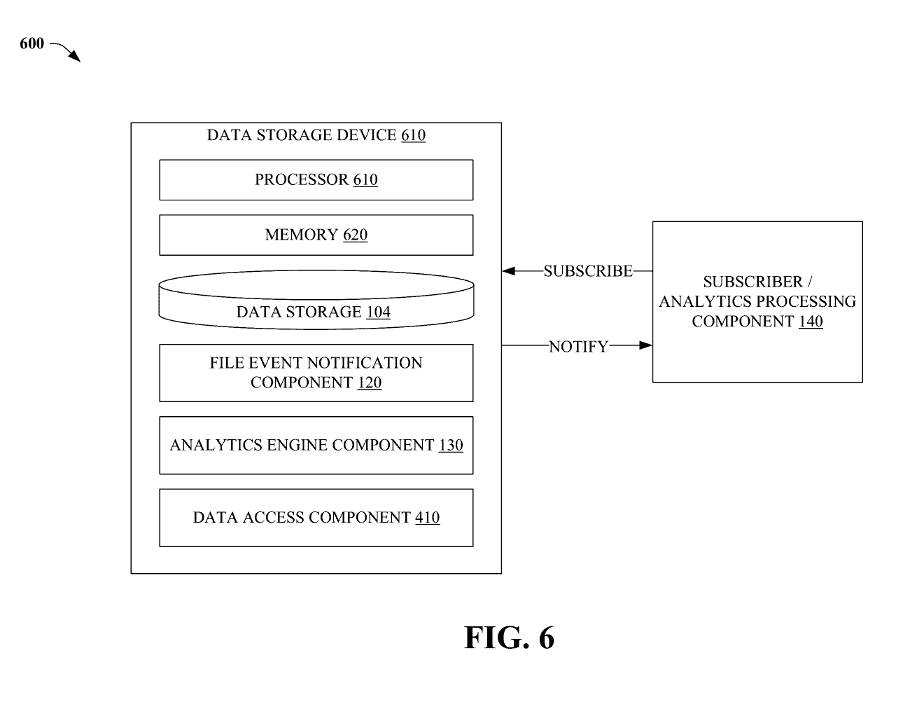

Now referring to FIG. 6, a block diagram (600) of a data storage device (610) comprising a data access component (410) is illustrated, in accordance with various example embodiments. Data storage device 610, e.g., a data server, can comprise a processor (610), and a memory (620) that stores instructions that, when executed by the processor, facilitate performance of various operations described above with respect to file event notification component 120, analytics engine component 130, and data access component 410.

In this regard, in an embodiment, the data server can be a virtual machine, a virtual storage appliance, e.g., within a cloud computing system. In another embodiment, data storage 104 can comprise virtual resources, e.g., virtual storage appliances allocated in hypervisor clusters, or virtual machine manager (VMM) clusters, as virtual machines, operating platforms, etc.

In one embodiment, the data server can communicate with a subscriber, e.g., subscriber/analytics processing component 140, utilizing an out-of-band network interface, e.g., Internet, etc. In this regard, in embodiment(s), the data server can communicate with the subscriber using a REST/RESTful based web service, e.g., utilizing an API corresponding to the subscriber that has been registered with the data server.

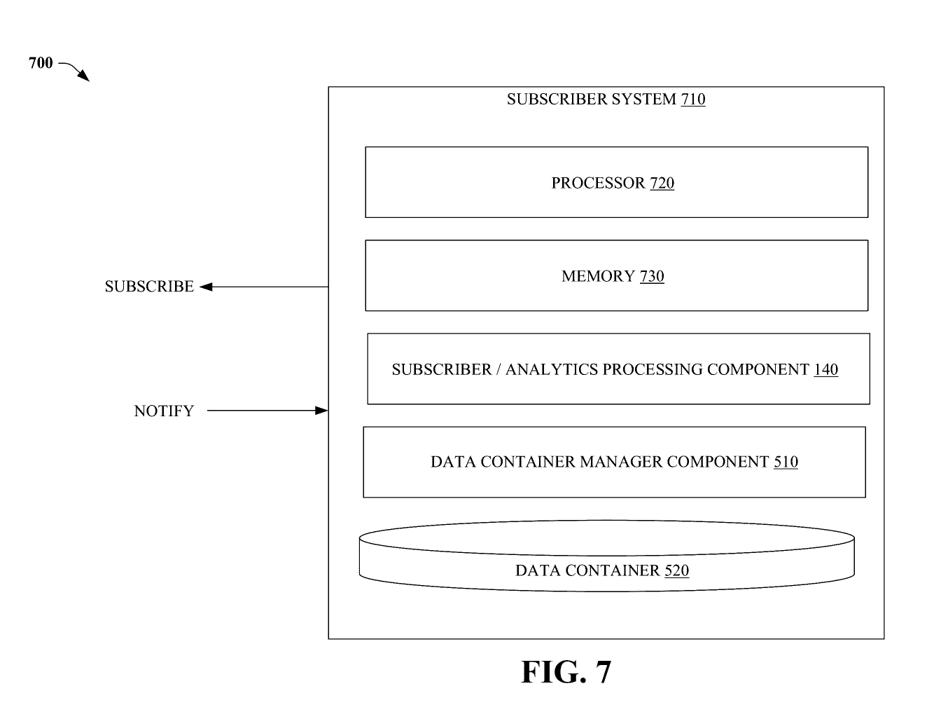

FIG. 7 illustrates a block diagram of a subscriber system (710) corresponding to a real-time data analytics service (e.g., 101), in accordance with various embodiments. Subscriber system 710 can comprise processor 720, and memory 730 that stores instructions that, when executed by the processor, facilitate performance of various operations described above with respect to subscriber/analytics processing component 140, and data container manager component 510. In this regard, subscriber system 710 can send a group of event subscription requests to analytics engine component 130 of a data storage device (e.g., 101, 201, 610)—the group of event subscription requests comprising, e.g., respective conditions for facilitating selection, by analytics engine component 130, of event notices corresponding to file activity, access events, e.g., activity 102, of a file of a storage device (104) that have been detected by analytics engine component 130.

In turn, based on the group of event subscription requests, subscriber system 710 can receive the event notices from the data storage device. In an embodiment, data container manager component 510 can store the event notices in data container 520, e.g., to be processed, via subscriber/analytics processing component 140, e.g., at a later time.

In another embodiment, subscriber system 710 can send, based on the event notices, respective read requests to the data storage device to instruct, e.g., data access component 410, to read portion(s) of the data storage device, e.g., specified in the read request. In turn, subscriber system 710 can receive the portion(s) from the data storage device, and store such portion(s), e.g., utilizing data container manager component 510, in data container 520, e.g., to perform customized, real-time analysis of such portion(s) corresponding to the event notices.

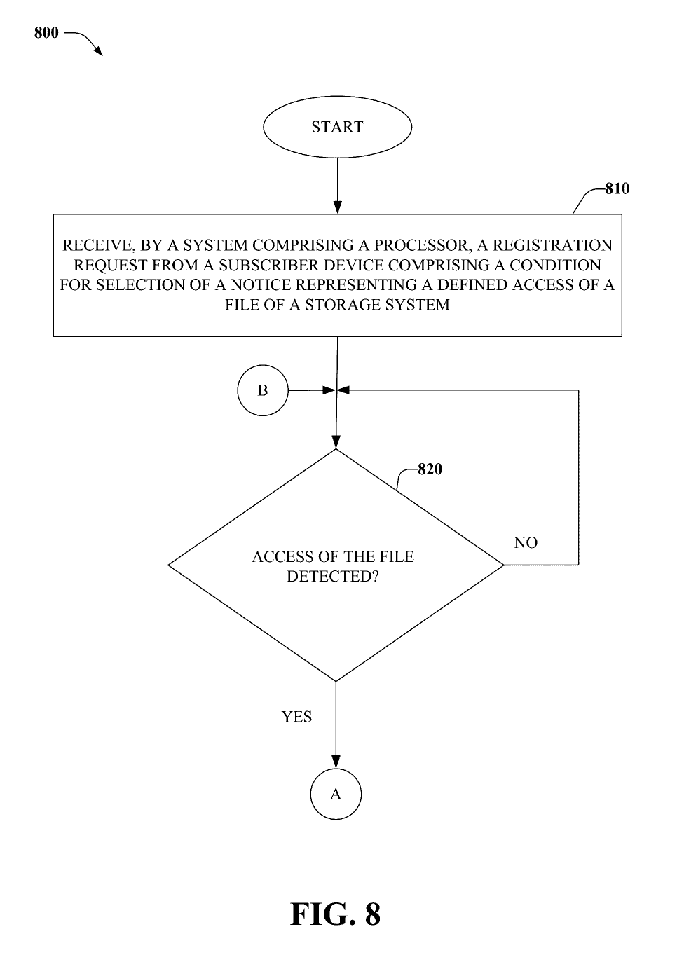

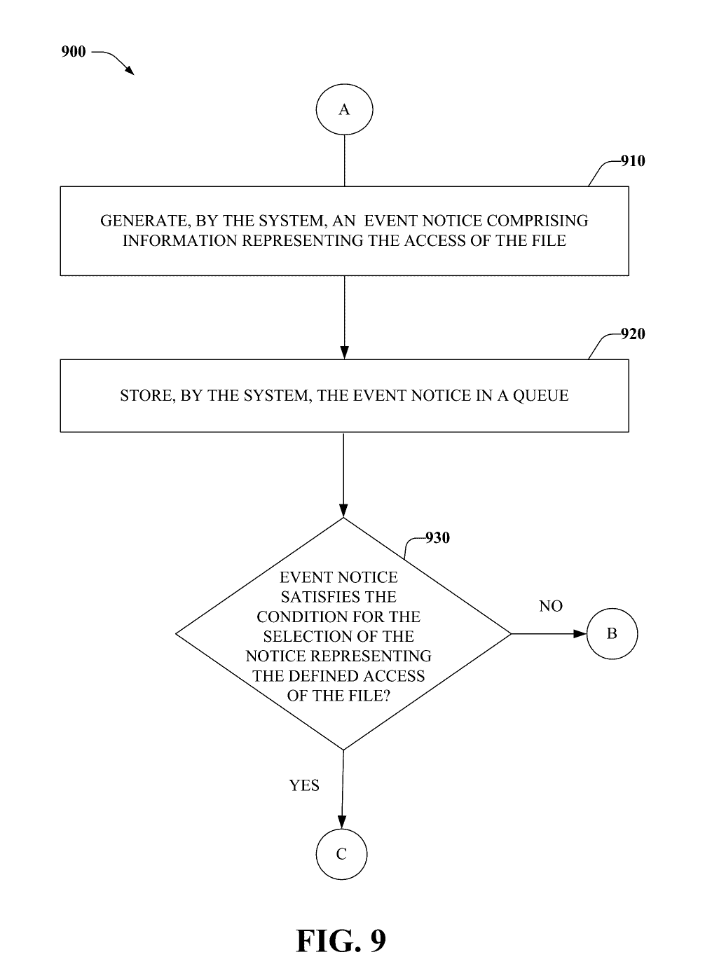

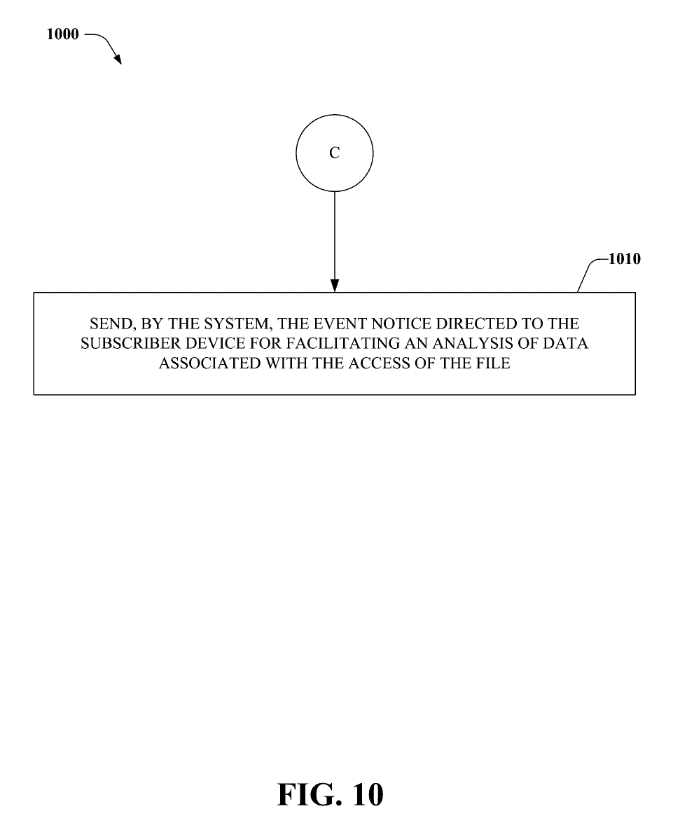

FIGS. 8-11 illustrate methodologies in accordance with the disclosed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIGS. 8-11, processes (800-1100) associated with an analytics engine component, e.g., 130, are illustrated, in accordance with various embodiments. At 810, a registration request comprising a condition for selection of a notice representing a defined access of a file of a storage system can be received. At 820, it can be determined whether an access of the file has been detected. In this regard, in response to determining that the access of the file has been detected, flow continues to 910, at which an event notice comprising information representing the access of the file can be generated; otherwise flow returns to 820.

From 910, flow continues to 920, at which the event notice can be stored in a queue, e.g., FIFO. At 930, it can be determined whether the event notice satisfies the condition for the selection of the notice representing the defined access of the file. In this regard, in response to determining that the event notice satisfies the condition for the selection of the notice, flow continues to 1010, at which the event notice can be sent to the subscriber device for facilitating an analysis of data associated with the access of the file; otherwise flow returns to 820.

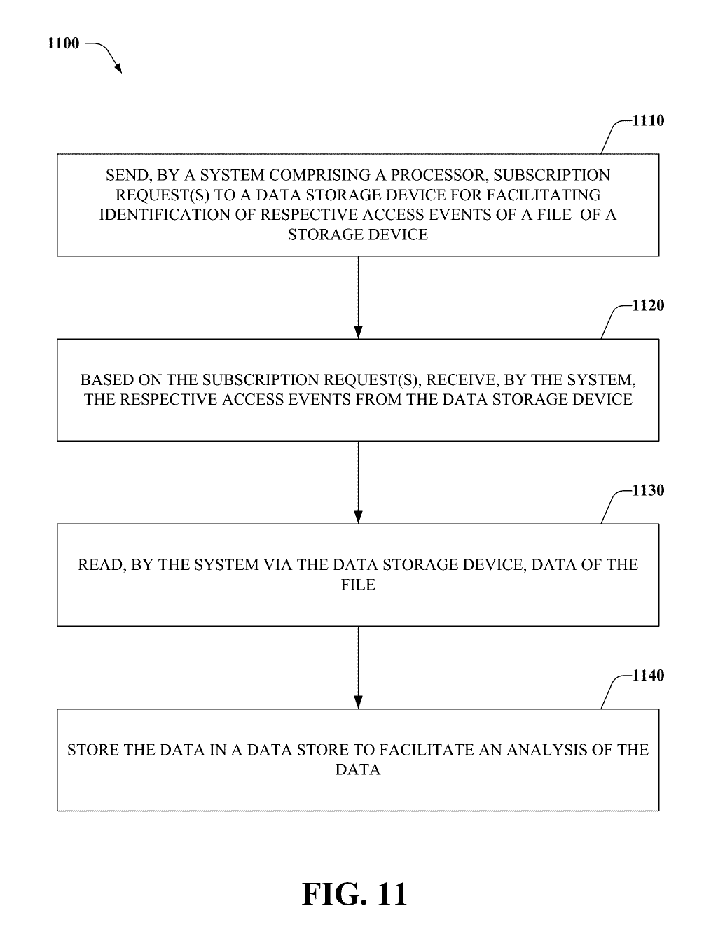

FIG. 11 illustrates a process (1100) associated with a subscriber system, e.g., 710, in accordance with various embodiments. At 1110, subscription request(s) can be sent to a data storage device (e.g., 610) for facilitating identification of respective access events of a file of a storage device. At 1120, the respective access events can be received from the data storage device based on the subscription request(s). At 1130, data of the file can read via the data storage device. At 1140, the data can be stored in a data store, e.g., 520, to facilitate an analysis of the data.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “data container,” “storage medium,” “storage media,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in data storage 104, block device 305, file system 307, data container 520, non-volatile memory 1222 (see below), disk storage 1224 (see below), and/or memory storage 1246 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

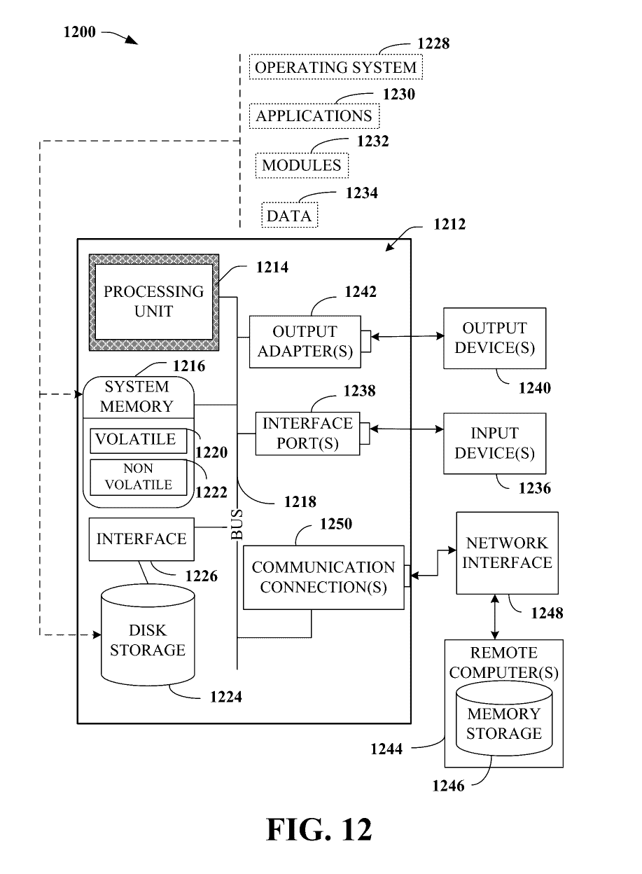

In order to provide a context for the various aspects of the disclosed subject matter, FIG. 12, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the subject innovation also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 12, a block diagram of a computing system 1200 operable to execute the disclosed components, systems, devices, methods, processes, etc., e.g., corresponding to 101, 201, 340, 342, 344, 346, 610, 710, etc. is illustrated, in accordance with an embodiment. Computer 1212 includes a processing unit 1214, a system memory 1216, and a system bus 1218. System bus 1218 couples system components including, but not limited to, system memory 1216 to processing unit 1214. Processing unit 1214 can be any of various available processors. Dual microprocessors and other multiprocessor architectures also can be employed as processing unit 1214.

System bus 1218 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), Small Computer Systems Interface (SCSI), and/or controller area network (CAN) bus used in vehicles.

System memory 1216 includes volatile memory 1220 and nonvolatile memory 1222. A basic input/output system (BIOS), containing routines to transfer information between elements within computer 1212, such as during start-up, can be stored in nonvolatile memory 1222. By way of illustration, and not limitation, nonvolatile memory 1222 can include ROM, PROM, EPROM, EEPROM, or flash memory. Volatile memory 1220 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 can also include removable/non-removable, volatile/non-volatile computer storage media, networked attached storage (NAS), e.g., SAN storage, etc. FIG. 12 illustrates, for example, disk storage 1224. Disk storage 1224 includes, but is not limited to, devices like a magnetic disk drive, floppy disk drive, tape drive, Jaz drive, Zip drive, LS-110 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to system bus 1218, a removable or non-removable interface is typically used, such as interface 1226.

It is to be appreciated that FIG. 12 describes software that acts as an intermediary between users and computer resources described in suitable operating environment 1200. Such software includes an operating system 1228. Operating system 1228, which can be stored on disk storage 1224, acts to control and allocate resources of computer system 1212. System applications 1230 take advantage of the management of resources by operating system 1228 through program modules 1232 and program data 1234 stored either in system memory 1216 or on disk storage 1224. It is to be appreciated that the disclosed subject matter can be implemented with various operating systems or combinations of operating systems.

A user can enter commands or information into computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1214 through system bus 1218 via interface port(s) 1238. Interface port(s) 1238 include, for example, a serial port, a parallel port, a game port, a universal serial bus (USB), a wireless based port, e.g., WiFi, Bluetooth®, etc. Output device(s) 1240 use some of the same type of ports as input device(s) 1236.

Thus, for example, a USB port can be used to provide input to computer 1212 and to output information from computer 1212 to an output device 1240. Output adapter 1242 is provided to illustrate that there are some output devices 1240, like display devices, light projection devices, monitors, speakers, and printers, among other output devices 1240, which use special adapters. Output adapters 1242 include, by way of illustration and not limitation, video and sound devices, cards, etc. that provide means of connection between output device 1240 and system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. Remote computer(s) 1244 can be a personal computer, a server, a router, a network PC, a workstation, a microprocessor based appliance, a peer device, or other common network node and the like, and typically includes many or all of the elements described relative to computer 1212.

For purposes of brevity, only a memory storage device 1246 is illustrated with remote computer(s) 1244. Remote computer(s) 1244 is logically connected to computer 1212 through a network interface 1248 and then physically and/or wirelessly connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refer(s) to hardware/software employed to connect network interface 1248 to bus 1218. While communication connection 1250 is shown for illustrative clarity inside computer 1212, it can also be external to computer 1212. The hardware/software for connection to network interface 1248 can include, for example, internal and external technologies such as modems, including regular telephone grade modems, cable modems and DSL modems, wireless modems, ISDN adapters, and Ethernet cards.

The computer 1212 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1212 can connect to other devices/networks by way of antenna, port, network interface adaptor, wireless access point, modem, and/or the like.

The computer 1212 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This includes at least WiFi and Bluetooth® wireless technologies. Thus, the communication can be a predefined structure as with a conventional network or simply an ad hoc communication between at least two devices.

WiFi allows connection to the Internet from a desired location (e.g., a vehicle, couch at home, a bed in a hotel room, or a conference room at work, etc.) without wires. WiFi is a wireless technology similar to that used in a cell phone that enables such devices, e.g., mobile phones, computers, etc., to send and receive data indoors and out, anywhere within the range of a base station. WiFi networks use radio technologies called IEEE 802.11 (a, b, g, etc.) to provide secure, reliable, fast wireless connectivity. A WiFi network can be used to connect communication devices (e.g., mobile phones, computers, etc.) to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Further, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used, via analytics engine component 130, to review event messages representing respective activities that have been performed on a file of a data storage device, and in response to determining that an event message of the event messages satisfies a defined notification criterion, send the event message directed to a subscriber device for facilitating a performance, by the subscriber device, of a customized analysis of data of an access corresponding to respective activities.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of event notifications reported by a file system, e.g., 310, 312, 314, etc., receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions, e.g., performed by analytics engine component 130, etc.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a first memory that stores executable instructions that, when executed by the processor, facilitate performance of operations, comprising:
receiving defined notification criteria from a group of subscriber devices;
registering with a file event notification component to receive file-system events from one or more file-systems;
in response to receiving the file-system events, generating subscriber event messages and storing the subscriber event messages in a second memory; and
in response to determining that a subscriber event message of the subscriber event messages satisfies a defined notification criterion of the defined notification criteria corresponding to a subscriber device of the group of subscriber devices, sending the subscriber event message directed to the subscriber device to facilitate an analysis of data corresponding to a file-system event of the file-system events.

2. The system of claim 1, wherein the file-system events represent that the file has been opened, closed, created, modified, read, or deleted.

3. The system of claim 1, wherein the generating the subscriber event messages comprises:
detecting an input/output (I/O) latency of the access or a data throughput associated with the access; and
adding information to the subscriber event message representing the I/O latency or the data throughput.

4. The system of claim 1, wherein the file event notification component utilizes at least one of: a filter driver that has been installed on the data storage device, a function call executed via the data storage device, or a device driver that has been installed on the data storage device.

5. The system of claim 1, wherein the data storage device comprises a block device, a network block device, or a file system.

6. The system of claim 1, wherein the subscriber event message comprises metadata representing the file-system event.

7. The system of claim 6, wherein the metadata represents at least one of: a type of the file, a file name of the file, an extension name of an extension of the file, a location of the file within the data storage device, an operation that has been performed on the file, a time corresponding to an initiation of the operation, a size of the file, or an entity identity representing an entity that performed the access.

8. The system of claim 1, wherein the receiving comprises receiving the defined notification criteria utilizing respective application programming interfaces of the group of subscriber devices.

9. The system of claim 1, wherein the facilitating the analysis of the file comprises facilitating at least one of: a performance analysis of the access, a security analysis of the access, or a file analysis of the access.

10. A method, comprising:
in response to detecting an activity being performed on a file of a data storage device, generating, by a system comprising a processor, an event notice comprising information representing the activity;
storing, by the system, the event notice in an event queue;
receiving, by the system, a registration request from a subscriber device comprising a defined condition for selection of the event notice from the event queue; and
in response to determining, based on the information, that the event notice satisfies the defined condition, sending, by the system, the event notice directed to the subscriber device for facilitating an analysis of data associated with the file.

11. The method of claim 10, wherein the detecting comprises:
detecting the activity using at least one of a filter driver operating on the data storage device, a device driver operating on the data storage device, or a function call of the data storage device.

12. The method of claim 11, wherein the generating comprises:
generating the event notice using at least one of the filter driver, the device driver, or the function call.

13. The method of claim 10, wherein the detecting the activity comprises detecting at least one of: a creation of the file, an access of the file, a modification of the file, a read of file, a write to the file, or a deletion of the file.

14. The method of claim 10, wherein the detecting the activity comprises:
detecting, based on a group of activities comprising the activity that that have been registered to be detected by the system via an application programming interface associated with the subscriber device, the activity.

15. A machine-readable storage medium, comprising executable instructions that, when executed by an analytics processing device comprising a processor, facilitate performance of operations, comprising:
sending a group of event subscription requests to an analytics engine device, wherein the group of event subscription requests facilitate identification of respective access events of a file; and
based on the group of event subscription requests, receiving the respective access events from the analytics engine device.

16. The machine-readable storage medium of claim 15, wherein the respective access events comprise at least one of: a creation of the file, an access of the file, a modification of the file, a read of file, a write to the file, or a deletion of the file.

17. The machine-readable storage medium of claim 15, wherein the sending comprises:
registering, via an application programming interface of the analytics engine device, the group of event subscription requests with the analytics engine device, wherein the group of event subscription requests comprises a subscribe function comprising function arguments for facilitating the identification of an access event of the respective access events.

18. The machine-readable storage medium of claim 17, wherein the function arguments specify at least one of: a type of the file, a file name of the file, an extension name of an extension of the file, a location of the file within the data storage device, an operation that has been performed on the file, a time corresponding to an initiation of the operation, a size of the file, or an entity identity representing an entity that performed the access.

19. The machine-readable storage medium of claim 17, wherein the function arguments comprise a regular expression syntax comprising a sequence of characters that define a search pattern.

20. The machine-readable storage medium of claim 15, wherein the operations further comprise:
reading, via the analytics engine device, data of the file; and
storing the data in data store to facilitate an analysis of the data.
